(19) United States
(12) Patent Application Publication
(10) Pub. No.: US 2017/0338033 A1
(43) Pub. Date: Nov. 23, 2017

(54) PULSE POWER MODULE

(71) Applicant: Gigaphoton Inc., Tochigi (JP)

(72) Inventor: Hiroshi UMEDA, Oyama-shi (JP)

(73) Assignee: Gigaphoton Inc., Tochigi (JP)

(21) Appl. No.: 15/671,660

(22) Filed: Aug. 8, 2017

Related U.S. Application Data
(63) Continuation of application No. PCT/JP2015/056831, filed on Mar. 9, 2015.

(51) Int. Cl. H01F 27/32; H01S 3/04; H01F 27/12; H01F 27/16; H01S 3/097; H01S 3/041

(52) U.S. Cl. CPC H01F 27/322; H01S 3/09702; H01S 3/041; H01F 27/12; H01F 27/324; H01F 27/16; H01S 3/0407

(57) ABSTRACT

To reduce the size of a magnetic circuit to be provided in a pulse power module for applying a high voltage in the form of a pulse across a pair of discharge electrodes which are disposed in a laser chamber of a gas laser apparatus, the magnetic circuit may include a magnetic core, an insulation member configured to contain a refrigerant flow path therein and cover the periphery of the magnetic core, and a winding wound around the insulation member.

### CROSS-REFERENCE TO RELATED APPLICATIONS

This application is a continuation application of International Application No. PCT/JP2015/056831 filed on Mar. 9, 2015. The content of the application is incorporated herein by reference in its entirety.

### BACKGROUND

### 1. Technical field

The disclosure relates to a pulse power module.

### 2. Related Art

With miniaturization and high integration of a semiconductor integrated circuit, improvement of resolution is demanded in a semiconductor exposure apparatus (hereinafter, referred to as an “exposure apparatus”). Accordingly, the wavelength of light emitted from a light source for exposure is being shortened. As the light source for exposure, a gas laser apparatus is used in place of an existing mercury lamp. As a gas laser apparatus for exposure, a KrF excimer laser apparatus that emits ultraviolet rays of a wavelength of 248 nm and an ArF excimer laser apparatus that emits ultraviolet rays of a wavelength of 193 nm are currently employed.

As a current exposure technology, liquid immersion exposure has been used in practice, wherein a gap between a projection lens on an exposure apparatus side and a wafer is filled with a liquid to change the refractive index of the gap, thereby shortening the apparent/virtual wavelength of the light source for exposure. In the liquid immersion exposure using the ArF excimer laser apparatus as the light source for exposure, ultraviolet rays having a wavelength of 134 nm in water/liquid is applied to the wafer. This technology is called ArF liquid immersion exposure or ArF liquid immersion lithography.

Because the spectrum line width in natural oscillations of the KrF and ArF excimer laser apparatuses is so wide, about 350 pm to about 400 pm, that a color aberration occurs in the laser light (ultraviolet rays) as projected in a reduced size on the wafer through the projection lens on the exposure apparatus side, degrading the resolution. Therefore, it is necessary to narrow the spectrum line width of the laser light emitted from the gas laser apparatus such that the color aberration becomes ignorable. The spectrum line width is also called the spectrum width. Accordingly, a line narrowing module (LNM) having a line narrowing element is provided in a laser resonator of the gas laser apparatus, to achieve narrowing the spectrum width by the line narrowing module. Note that the line narrowing element may include an etalon, a grating and the like. The laser apparatus with a spectrum width narrowed in this way is called a narrow-band laser apparatus.

### CITATIONS

### Patent Literature

PTL 1: U.S. Pat. No. 6,198,761
PTL 2: U.S. Pat. No. 6,999,492
PTL 3: US Patent Application Publication No. 2006/0222034
PTL 4 Japanese Patent Application Publication No. 2005-347586
PTL 5: Japanese Patent No. 4101579
PTL 6: Japanese Patent Application Publication No. H5-55057

### SUMMARY

A pulse power module according to one aspect of the present disclosure, which applies a high voltage in the form of a pulse across a pair of discharge electrodes disposed in a laser chamber of a gas laser apparatus, may include a magnetic circuit. The magnetic circuit may include a magnetic core, an insulation member configured to contain a refrigerant flow path therein and cover the periphery of the magnetic core, and a winding wound around the insulation member.

### BRIEF DESCRIPTION OF DRAWINGS

Some embodiments of the disclosure will be described as an example below with reference to the accompanying drawings.

FIG. 1 is a diagram illustrating a gas laser apparatus and a charge-discharge circuit thereof.

FIG. 2 is a diagram illustrating a structure of a magnetic switch shown in FIG. 1.

FIG. 3A is a diagram illustrating a magnetic circuit provided in a pulse power module according to a first embodiment.

FIG. 3B is a sectional view taken along a line A1-A2 shown in FIG. 3A.

FIG. 4A is a diagram illustrating a magnetic circuit provided in a pulse power module according to a second embodiment.

FIG. 4B is a sectional view taken along a line B1-B2 shown in FIG. 4A.

FIG. 5 is a flowchart illustrating a process sequence for manufacturing the magnetic circuit shown in FIG. 4A and FIG. 4B.

FIG. 6A is a diagram illustrating a magnetic circuit provided in a pulse power module according to a third embodiment.

FIG. 6B is a sectional view taken along a line C1-C2 shown in FIG. 6A.

FIG. 6C is a sectional view taken along a line C1-C3 shown in FIG. 6A.

FIG. 7A is a diagram illustrating a magnetic circuit provided in a pulse power module according to a fourth embodiment.

FIG. 7B is a sectional view taken along a line D1-D2 shown in FIG. 7A.

FIG. 8A is a diagram illustrating a magnetic circuit provided in a pulse power module according to a fifth embodiment.

FIG. 8B is a sectional view taken along a line E1-E2 shown in FIG. 8A.

FIG. 9 is a diagram illustrating a modification of a magnetic core.

### EMBODIMENTS

### Contents

1. Overview
2. Terms
3. Gas Laser Apparatus and Charge-discharge Circuit thereof
3.1 Configuration
3.2 Operation
3.3 Magnetic Circuit
4. Problem
5. Magnetic Circuit in Pulse Power Module of First Embodiment
5.1 Configuration
5.2 Operation
5.3 Effect
6. Magnetic Circuit in Pulse Power Module of Second Embodiment
6.1 Configuration
6.2 Manufacturing Process
7. Magnetic Circuit in Pulse Power Module of Third Embodiment
8. Magnetic Circuit in Pulse Power Module of Fourth Embodiment
9. Magnetic Circuit in Pulse Power Module of Fifth Embodiment
10. Others
10.1 Modification of Magnetic Core
10.2 Other Modifications, etc.

In the following, some embodiments of the disclosure are described in detail with reference to the drawings. Embodiments described below each illustrate one example of the disclosure and are not intended to limit the contents of the disclosure. Also, all of the configurations and operations described in each embodiment are not necessarily essential for the configurations and operations of the disclosure. Note that like elements are denoted with the same reference numerals, and any redundant description thereof is omitted.

### 1. Overview

The present disclosure can at least disclose the following embodiments merely as examples.

A pulse power module 40 according to one aspect of the present disclosure, which applies a high voltage in the form of a pulse across a pair of discharge electrodes 11a and 11b disposed in a laser chamber 10 of a gas laser apparatus 1, may comprise a magnetic circuit 5 including a magnetic core 50, an insulation member 60 that contains a refrigerant flow path 70 therein and covers the periphery of the magnetic core 50, and a winding 80 wound around the insulation member 60.

This configuration of the pulse power module 40 makes it possible to adequately cool the magnetic circuit 5 even in air and miniaturize and lighten the pulse power module 40.

### 2. Terms

“Optical path axis” is an axis extending in a traveling direction of a laser light through the beam sectional center of the laser light.

“Optical path” is a path along which the laser light travels. The optical path may include the optical path axis.

### 3. Gas Laser Apparatus and Charge-Discharge Circuit Thereof

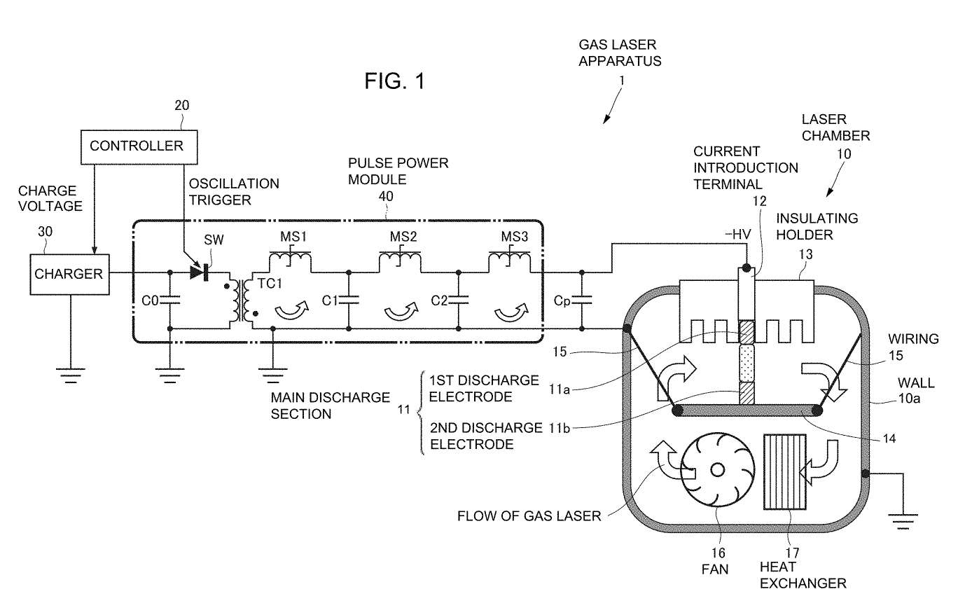

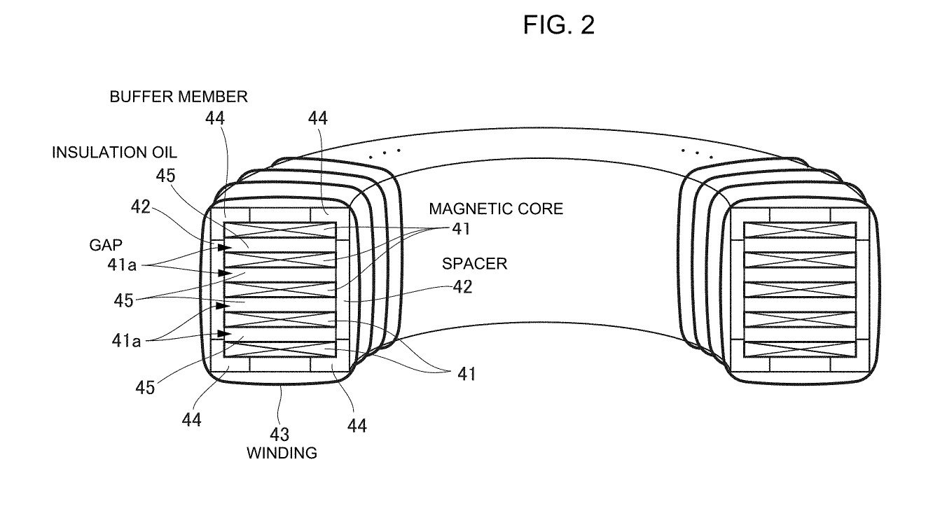

A gas laser apparatus 1 and a charge-discharge circuit thereof will be described using FIG. 1 and FIG. 2.

The gas laser apparatus 1 shown in FIG. 1 may be a discharge excitation gas laser apparatus. The gas laser apparatus 1 may be an excimer laser apparatus. A laser gas, which is a laser medium, may be composed of argon or krypton as a rare gas, fluorine as a halogen gas, neon or helium as a buffer gas, or a mixed gas thereof.

### 3.1 Configuration

FIG. 1 is a diagram illustrating the gas laser apparatus 1 and the charge-discharge circuit thereof.

The gas laser apparatus 1 may be provided with the laser chamber 10, a controller 20, a charger 30, a peaking capacitor Cp and a pulse power module (PPM) 40.

The laser chamber 10 may have a laser gas encapsulated therein.

A wall 10a that forms an internal room of the laser chamber 10 may be formed, for example, of a metal material such as an aluminum metal. The surface of the metal material may be treated with nickel plating, for example.

The wall 10a of the laser chamber 10 may be grounded to the earth.

The laser chamber 10 may include a main discharge section 11, a current introduction terminal 12, an insulating holder 13, a conductive holder 14, wirings 15, a fan 16 and a heat exchanger 17.

The main discharge section 11 may include a first discharge electrode 11a and a second discharge electrode 11b.

The first and second discharge electrodes 11a and 11b may be a pair of discharge electrodes for exciting the laser gas with main electric discharge. The main electric discharge may be glow discharge.

The first and second discharge electrodes 11a and 11b may be each formed of a metal material including copper.

The first and second discharge electrodes 11a and 11b may be spaced a given distance apart from each other and arranged in face to each other and with the longitudinal direction thereof in parallel to each other.

The first and second discharge electrodes 11a and 11b may be a cathode electrode and an anode electrode, respectively.

One side of the first discharge electrode 11a facing the second discharge electrode 11b and one side of the second discharge electrode 11b facing the first discharge electrode 11a may also be called the “discharge surface” each.

A space between the discharge surface of the first discharge electrode 11a and that of the second discharge electrode 11b may also be called the “discharge space”.

One end of the current introduction terminal 12 may be connected to a bottom surface of the first discharge electrode 11a, which is opposite to the discharge surface.

The other end of the current introduction terminal 12 may be connected to a negative output terminal of the pulse power module 40 through the peaking capacitor Cp.

The insulating holder 13 may hold the first discharge electrode 11a and the current introduction terminal 12 so as to surround the side surfaces of the first discharge electrode 11a and the current introduction terminal 12.

The insulating holder 13 may be formed of an insulating material that is less reactive with the laser gas. In the case where the laser gas contains fluorine or chlorine, the insulating holder 13 may be formed of high purity alumina ceramics, for example.

The insulating holder 13 may be connected to the wall 10a of the laser chamber 10.

The insulating holder 13 may electrically insulate the first discharge electrode 11a and the current introduction terminal 12 from the wall 10a of the laser chamber 10.

The conductive holder 14 may be connected to an opposite surface of the second discharge electrode 11b to the discharge surface, and may hold the second discharge electrode 11b.

The conductive holder 14 may be formed of a metal material including aluminum, copper and the like.

One end of a wiring 15 may be connected to the conductive holder 14.

The other end of the wiring 15 may be connected to a ground terminal of the pulse power module 40 through the wall 10a of the laser chamber 10 and the peaking capacitor Cp.

More than one wiring 15 may be provided along the length of the first and second discharge electrodes 11a and 11b, at predetermined spacing from each other.

The fan 16 may circulate the laser gas inside the laser chamber 10.

The fan 16 may be a cross-flow fan.

The fan 16 may be arranged such that the longitudinal direction of the fan 16 is substantially parallel to the longitudinal direction of the first and second discharge electrodes 11a and 11b.

The fan 16 may be connected to a not-shown motor. The operation of the motor may be controlled by the controller 20.

The heat exchanger 17 may exchange heat energy between a refrigerant supplied into the heat exchanger 17 and the laser gas.

The operation of the heat exchanger 17 may be controlled by the controller 20.

The controller 20 may comprehensively control the respective operations of the components of the gas laser apparatus 1 on the basis of various kinds of signals transmitted from an exposure apparatus.

The charger 30 may be a direct-current power supply device that charges a charging capacitor C0 of the pulse power module 40.

The operation of the charger 30 may be controlled by the controller 20.

The peaking capacitor Cp may discharge the electric charges, charged by the pulse power module 40, to the first discharge electrode 11a.

The peaking capacitor Cp may be disposed between the pulse power module 40 and the laser chamber 10.

Alternatively, the peaking capacitor Cp may be placed inside the laser chamber 10. In this case, the area size of a region surrounded by a current path that constitutes a discharge circuit of the gas laser apparatus 1 will be reduced so that the discharge circuit can provide a smaller inductance. Thus, the energy loss at the discharge circuit can be preferably reduced.

The pulse power module 40 may apply the high-voltage pulse across the first and second discharge electrodes 11a and 11b through the peaking capacitor Cp.

The pulse power module 40 may include a semiconductor switch SW, a transformer TC1, magnetic switches MS1 to MS3, the charging capacitor C0 and capacitors C1 and C2. The pulse power module 40 may further include an insulation oil (not-shown) for cooling these elements and a radiator (not-shown) for cooling the insulation oil.

The semiconductor switch SW may be provided between the transformer TC1 and the charging capacitor C0.

The operation of the semiconductor switch SW may be controlled by the controller 20.

The magnetic switch MS1 may be provided between the secondary side of the transformer TC1 and the capacitor C1.

The magnetic switch MS2 may be provided between the capacitor C1 and the capacitor C2.

The magnetic switch MS3 may be provided between the capacitor C2 and the peaking capacitor Cp.

When the time integral value of the voltage applied to the magnetic switches MS1 to MS3 reaches a threshold level, the magnetic switches MS1 to MS3 come to conduct the current easily. The threshold levels for the respective magnetic switches MS1 to MS3 may be different from each other. At that time, the magnetic cores included in the magnetic switches MS1 to MS3 may be magnetically saturated, as described later.

The state of the magnetic switch MS1, M2 or M3 in which the current flows easily therethrough may also be referred to as “the magnetic switch is closed”.

The primary side and the secondary side of the transformer TC1 may be electrically insulated from each other. The winding direction of the primary coil of the transformer TC1 may be reverse to the winding direction of the secondary coil. The winding number of the secondary coil of the transformer TC1 may be greater than the winding number of the primary coil.

### 3.2 Operation

The controller 20 may control the not-shown motor to turn the fan 16.

The laser gas inside the laser chamber 10 can circulate. The laser gas can flow through the discharge space between the first discharge electrode 11a and the second discharge electrode 11b.

The controller 20 may set a high-level charge voltage Vhv at the charger 30.

The charger 30 can charge the charging capacitor C0 based on the set charge voltage Vhv.

The controller 20 may output an oscillation trigger signal to the semiconductor switch SW to start laser oscillation.

When the oscillation trigger signal is input in the semiconductor switch SW, the semiconductor switch SW can be turned ON. When the semiconductor switch SW is turned ON, a pulsing current can flow to the primary side of the transformer TC1.

When the current flows to the primary side of the transformer TC1, a pulsing current can flow through the secondary side of the transformer TC1 due to electromagnetic induction. As the current flows through the secondary side of the transformer TC1, the time integration value of the voltage applied to the magnetic switch MS1 can finally reach the threshold level.

When the time integration value of the voltage applied to the magnetic switch MS1 reaches the threshold level, the magnetic switch MS1 gets to a magnetically saturated state and the magnetic switch MS1 can be closed.

When the magnetic switch MS1 is closed, the current can flow from the secondary side of the transformer TC1 to the capacitor C1, charging the capacitor C1. At that time, the pulse width of the current charging the capacitor C1 can be reduced. The voltage level at the capacitor C1 can become negative.

As the current flows through the capacitor C1, the time integration value of the voltage applied to the magnetic switch MS2 can finally reach the threshold level, and the magnetic switch MS1 can be closed.

When the magnetic switch MS2 is closed, the current can flow from the capacitor C1 to the capacitor C2, charging the capacitor C2. At that time, the pulse width of the current charging the capacitor C2 can be shorter than the pulse width of the current charging the capacitor C1. The voltage level at the capacitor C2 can become negative.

As the current flows through the capacitor C2, the time integration value of the voltage applied to the magnetic switch MS3 can finally reach the threshold level, and the magnetic switch MS1 can be closed.

When the magnetic switch MS3 is closed, the current can flow from the capacitor C2 to the peaking capacitor Cp, charging the peaking capacitor Cp. At that time, the pulse width of the current charging the peaking capacitor Cp can be shorter than the pulse width of the current charging the capacitor C2. The voltage level at the peaking capacitor Cp can become negative.

Thus, as the current flows sequentially from the capacitor C1 to the capacitor C2 and from the capacitor C2 to the peaking capacitor Cp, the pulse width of the current can be compressed.

As being charged, the peaking capacitor Cp can apply a pulsing high-level voltage across the first and second discharge electrodes 11a and 11b.

When the pulsing high-level voltage applied to the first and second discharge electrodes 11a and 11b becomes higher than a withstand voltage of the laser gas, the laser gas can dielectrically break down.

When the laser gas dielectrically breaks down, a main discharge can occur in the discharge space between the first and second discharge electrodes 11a and 11b. At that time, the direction in which electrons move at the main discharge can be from the first discharge electrode 11a being the cathode electrode to the second discharge electrode 11b being the anode electrode.

The occurrence of the main discharge enables exciting the laser gas to emit light in the discharge space between the first and second discharge electrodes 11a and 11b.

The light emitted from the laser gas can be reflected by an output coupler and a rear mirror, which are not shown but constitute a laser resonator of the gas laser apparatus, and thus reciprocate inside the laser resonator.

The light reciprocating within the laser resonator can be amplified at each passage through the discharge space, providing a laser oscillation.

Thereafter, part of the amplified light can penetrate through the output coupler and thus be output as pulse laser light to the exposure apparatus.

Furthermore, when the main discharge occurs, discharge products can be produced in the discharge space between the first and second discharge electrodes 11a and 11b. The discharge products can move apart from the discharge space along with the flow of the laser gas that flows through the discharge space.

The laser gas flowing through the discharge space can flow to the heat exchanger 17, being cooled while passing through the heat exchanger 17. After passing through the heat exchanger 17, the laser gas can pass through the fan 16 and thus circulate inside the laser chamber 10.

As a result, the gas laser apparatus 1 can output the pulse laser light repeatedly at a frequency corresponding to the circulation of the laser gas.

### 3.3. Magnetic Circuit

The configuration of the magnetic switches MS1 to MS3 and the transformer TC1, which constitute a kind of magnetic circuit that is used in the pulse power module 40 shown in FIG. 1, will be schematically described.

In the following description, the magnetic switch MS1 will be described as a representative among the magnetic circuit used in the pulse power module 40.

FIG. 2 is a diagram schematically illustrating the configuration of the magnetic switch MS1 shown in FIG. 1.

The magnetic switch MS1 may include a magnetic core 41, a spacer 42, a winding 43, a buffer member 44 and an insulation oil 45.

The magnetic switch MS1 may have a plurality of magnetic cores 41 arranged in a multistage structure.

Each of the multistage magnetic cores 41 may be formed into a substantially annular shape.

The multistage magnetic cores 41 may be piled in a stack in the direction of the respective center axes, which are substantially aligned to each other, with a given distance apart from each other to provide gaps 41a therebetween.

The spacers 42 may hold the multistage magnetic cores 41 so as to keep the gaps 41a between the magnetic cores 41.

The winding 43 may be wound around the total stack of magnetic cores 41 held by the spacers 42.

The winding 43 may be formed by shielding a metal wire with a coat of insulating paper.

The buffer member 44 may be a member that suppresses discharges between the magnetic cores 41 and the winding 43.

The buffer members 44 may be placed between the magnetic cores 41 and the winding 43 at the corners of the total stack of magnetic cores 41 held by the spacers 42.

The magnetic switch MS1 may be used in a state placed within a not-shown tank that is filled with the insulation oil 45, thereby to cool the magnetic switch MS1. That is, the magnetic switch MS1 may be used in a state soaked in the insulation oil 45.

The insulation oil 45 may be caused to flow on the surfaces of the magnetic cores 41 by natural convection or forced convection provided by a not-shown fan installed in the tank. Thus, the gaps 41a between the adjacent magnetic cores 41 can be filled with the insulation oil 45. The insulation oil 45 can make heat-exchange with the magnetic cores 41 to cool the magnetic cores 41.

The magnetic switches MS2 and MS3 and the transformer TC1 may have similar multistage structures to that of the magnetic switch MS1.

### 4. Problem

As described above, where the magnetic circuit for the pulse power module 40 is used in a state placed in a tank filled with the insulation oil 45, the tank can take up a large space in the pulse power module 40 in terms of volume.

Furthermore, since the magnetic circuit for the pulse power module 40 has the multistage structure in which the gaps 41a are formed between the multiple magnetic cores 41, the mere volume of the magnetic cores included in one magnetic circuit can be large.

In addition, the large volume of the magnetic cores as the whole can result in a large inductance of the magnetic circuit after the magnetic saturation of the magnetic cores. As the inductance of the magnetic circuit increases, the heat energy from the magnetic circuit increases, so that the magnetic circuit can tend to have a high temperature and thus break down more easily.

The pulse power module 40 with this type of magnetic circuit can be large and heavy.

Therefore, there is a demand for a technique that provides a small and light magnetic circuit which can be adequately cooled even while used in air, thus making the pulse power module 40 smaller and lighter.

### 5. Magnetic Circuit in Pulse Power Module of First Embodiment

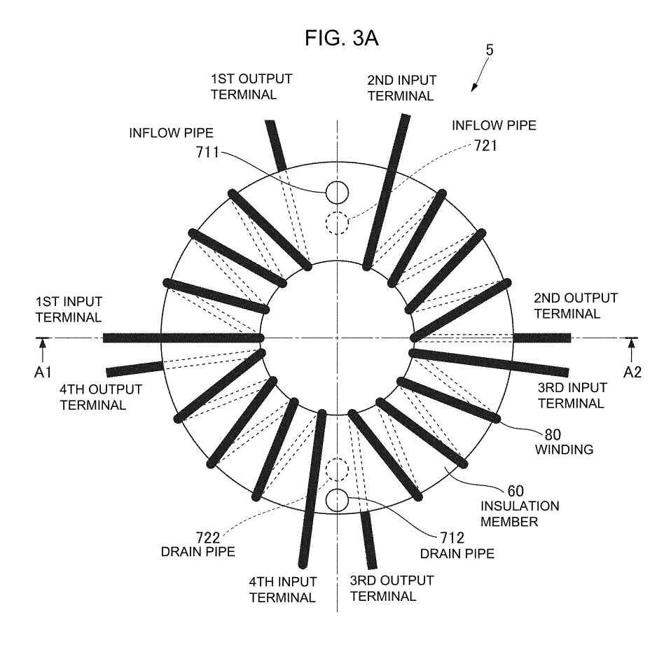

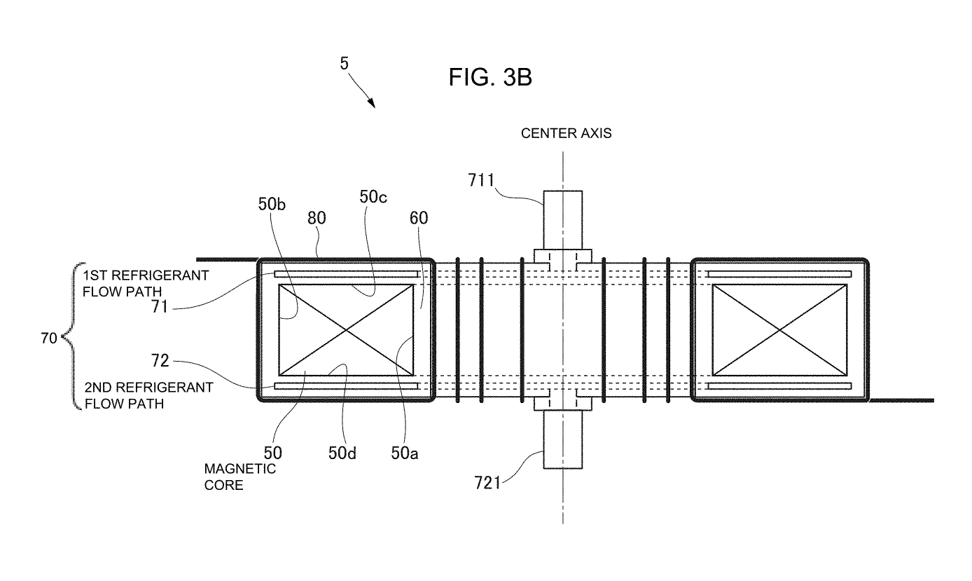

A magnetic circuit 5 provided in a pulse power module 40 of the first embodiment will be described using FIG. 3A and FIG. 3B.

The pulse power module 40 of the first embodiment may be mainly different from the pulse power module 40 shown in FIG. 1 with respect to the configuration of the magnetic circuit.

The magnetic circuit 5 involved in the first embodiment may be applied to the magnetic switches MS1 to MS3 and the transformer TC1 which are shown in FIG. 1.

Hereinafter, a representative case where the magnetic circuit 5 provided in the pulse power module 40 of the first embodiment is applied to the magnetic switch MS1 will be described.

In the configuration of the pulse power module 40 of the first embodiment, the description of similar features to those of the pulse power module 40 shown in FIG. 1 will be omitted.

### 5.1 Configuration

FIG. 3A is a diagram illustrating the magnetic circuit 5 provided in the pulse power module 40 of the first embodiment. FIG. 3B is a sectional view taken along a line A1-A2 shown in FIG. 3A.

The magnetic circuit 5 shown in FIG. 3A and FIG. 3B may be used in air, not in a state soaked in an insulation oil 45.

The magnetic circuit 5 may include a magnetic core 50, an insulation member 60, a refrigerant flow path 70 and a winding 80.

The magnetic core 50 may not necessarily have magnetic cores stacked in a multistage structure.

The magnetic core 50 may be formed to have a rectangular section and a substantially annular shape.

The magnetic core 50 may be formed to have a first surface 50a that is an inner circumferential surface of the magnetic core 50, a second surface 50b that is an outer circumferential surface of the magnetic core 50, a third surface 50c that is substantially perpendicular to a center axis of the magnetic core 50, and a fourth surface 50d that is perpendicular to the center axis of the magnetic core 50 and on the opposite side to the third surface 50c.

The magnetic core 50 may be formed of a ferromagnetic material.

The material of the magnetic core 50 may be a material that has a low coercive force and a high magnetic permeability in the B-H curve representing the relation between magnetic flux density and magnetic field.

The material of the magnetic core 50 may be, for example, a metal such as iron, nickel or cobalt, or an alloy of these metals. Preferably, the magnetic core 50 may be formed of a nano crystalline soft magnetic material. The nano crystalline soft magnetic material may be FINEMET™.

The insulation member 60 may electrically insulate the magnetic core 50.

The insulation member 60 may cover the periphery of the magnetic core 50. Namely, the insulation member 60 may cover the first to fourth surfaces 50a, 50b, 50c and 50d.

The insulation member 60 may be formed of an insulating material having a high thermal conductivity. The insulation member 60 may be formed of a ceramic material including at least one of alumina, yttria and aluminum nitride, for example.

The insulation member 60 may contain the refrigerant flow path 70 therein.

The refrigerant flow path 70 may be a flow path in which a refrigerant flows. The refrigerant may be cooling water.

The refrigerant flow path 70 may include a first refrigerant flow path 71 and a second refrigerant flow path 72.

The first refrigerant flow path 71 may be formed to extend in the circumferential direction of the magnetic core 50 that has a substantially annular shape.

The first refrigerant flow path 71 may be located inside the insulation member 60 that covers the third surface 50c of the magnetic core 50. Inside the insulation member 60, the first refrigerant flow path 71 may be placed in face to the third surface 50c of the magnetic core 50.

The first refrigerant flow path 71 may be provided with an inlet port for the refrigerant to flow into the path, and an outlet port for the refrigerant to flow out of the path. The inlet port and the outlet port may be connected to an inflow pipe 711 and a drain pipe 712, respectively, which are connected to an external radiator and the like.

The second refrigerant flow path 72 may be formed to extend in the circumferential direction of the magnetic core 50 that has a substantially annular shape.

The second refrigerant flow path 72 may be located inside the insulation member 60 that covers the fourth surface 50d of the magnetic core 50. Inside the insulation member 60, the second refrigerant flow path 72 may be placed in face to the fourth surface 50c of the magnetic core 50.

The second refrigerant flow path 72 may be provided with an inlet port for the refrigerant to flow into the path, and an outlet port for the refrigerant to flow out of the path. The inlet port and the outlet port may be connected to an inflow pipe 721 and a drain pipe 722, respectively, which are connected to an external radiator and the like.

The winding 80 may constitute a coil.

The winding 80 may be formed by coating a metal wire, such as a copper wire, with an insulating material.

The winding 80 may be wound around the magnetic core 50 which has been covered with the insulation member 60. The winding 80 may be wound around the insulation member 60 that covers the magnetic core 50, in a given winding number and at given intervals.

It may be possible to wind more than one winding, for example, four windings as shown in FIG. 3A. Respective ends of the four windings 80 may constitute first to fourth input terminals and first to fourth output terminals.

Other features of the pulse power module 40 of the first embodiment may be similar to those of the pulse power module 40 shown in FIG. 1.

### 5.2 Operation

The operation of the pulse power module 40 according to the first embodiment will be described.

In the operation of the pulse power module 40 of the first embodiment, the description of similar operation processes to those of the pulse power module 40 will be omitted.

In the magnetic circuit 5 involved in the first embodiment, a pulsing current may enter through the input terminal of the winding 80.

When the current flows from the input terminal through the winding 80, a magnetic field is generated and applied to the magnetic core 50.

Before the magnetic core 50 reaches a magnetically saturated state, the inductance of the magnetic circuit 5 increases, enabling suppressing the current flow.

When the magnetic core 50 reaches the magnetically saturated state, the inductance of the magnetic circuit 5 decreases, enabling magnifying the current flow.

Meanwhile, the heat generated from the magnetic core 50 is transmitted through the insulation member 60 to the refrigerant inside the refrigerant flow path 70, enabling evacuating the heat to the outside. Thus, the temperature of the magnetic core 50 can be prevented from increasing.

Accordingly, it is possible for the magnetic circuit 5 to suppress the increase in inductance and thus suppress the current loss through the winding 80.

Otherwise, the pulse power module 40 of the first embodiment may operate equivalently to the pulse power module 40 shown in FIG. 1.

### 5.3 Effect

In the magnetic circuit 5 involved in the first embodiment, the periphery of the magnetic core 50 is covered with the insulation member 60 that contains the refrigerant flow path 70 therein, enabling cooling the magnetic core 50 while keeping the electric insulation.

Furthermore, in the magnetic circuit 5 involved in the first embodiment, the refrigerant flow path 70 is located in face to the third and fourth surfaces 50c and 50d of the magnetic core 50, which are more likely to generate heat; thus, the magnetic core 50 can be cooled more easily.

In addition, because the magnetic circuit 5 involved in the first embodiment uses cooling water having a higher thermal conductivity than the insulation oil 45 as the refrigerant in the refrigerant flow path 70, the magnetic core 50 can be still more easily cooled.

Therefore, it can be unnecessary for the magnetic circuit 5 involved in the first embodiment to use magnetic cores of a multistage structure, which are soaked in the insulation oil 45.

Accordingly, the magnetic circuit 5 involved in the first embodiment can be adequately cooled even while used in air and can also be reduced in size and weight.

As a result, the pulse power module 40 of the first embodiment can be reduced in size and weight.

### 6. Magnetic Circuit in Pulse Power Module of Second Embodiment

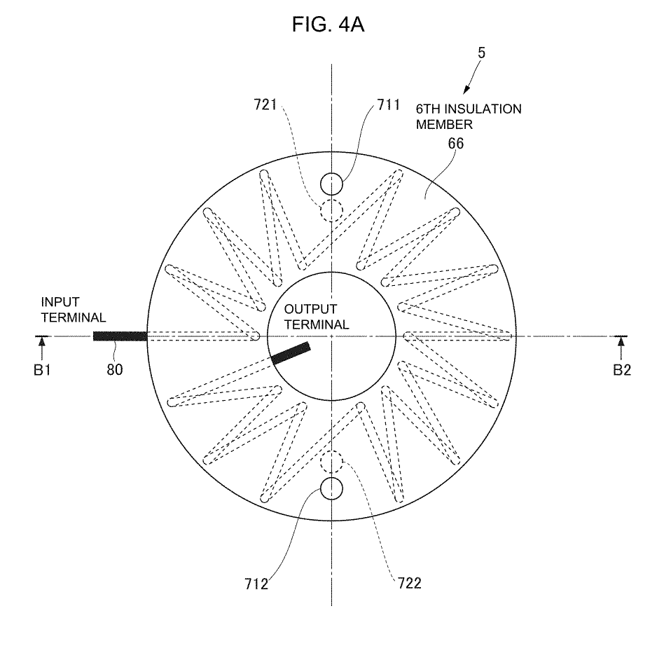

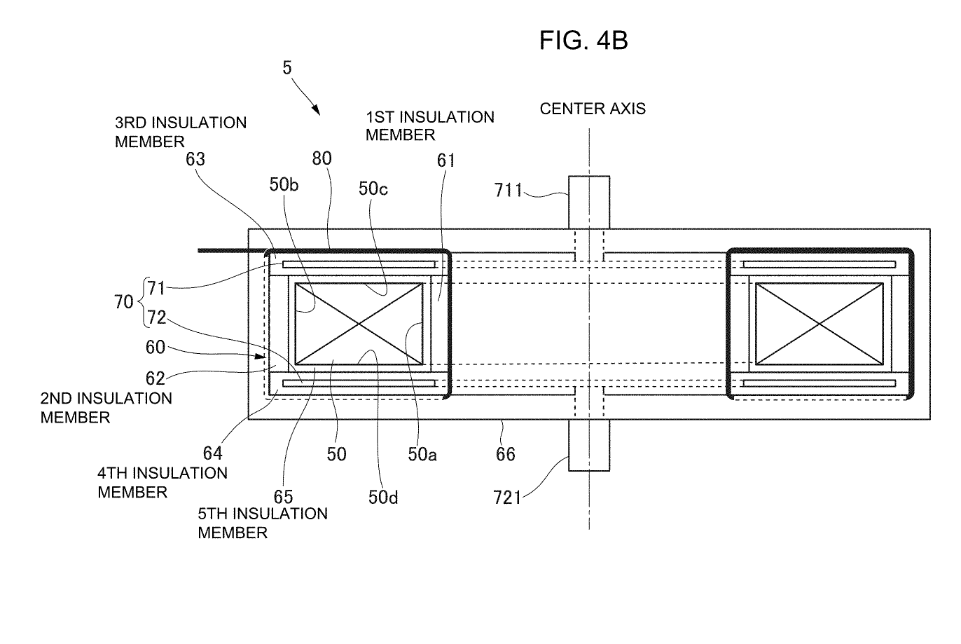

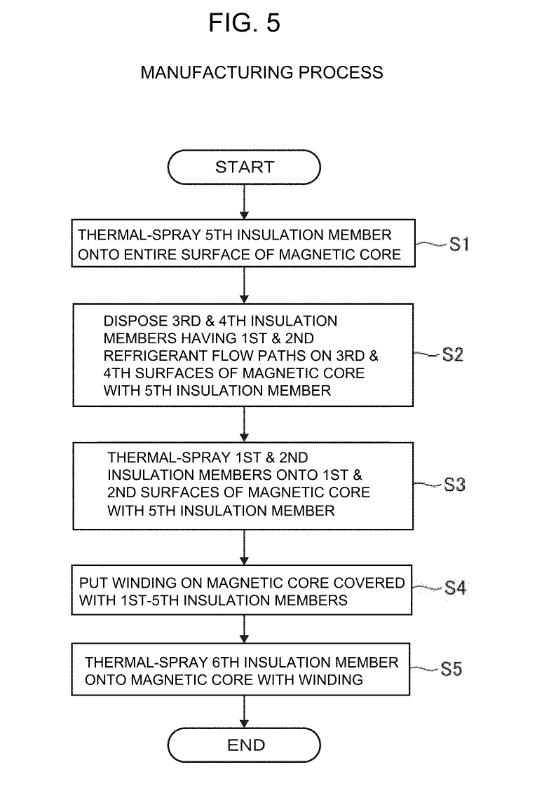

A magnetic circuit 5 provided in a pulse power module of the second embodiment will be described using FIG. 4A to FIG. 5.

The magnetic circuit 5 involved in the second embodiment may be configured to have a different insulation member 60 from that of the magnetic circuit 5 involved in the first embodiment.

Furthermore, the magnetic circuit 5 involved in the second embodiment may be configured to have additional fifth and sixth insulation members 65 and 66 in comparison with the magnetic circuit 5 involved in the first embodiment.

In the configuration of the pulse power module 40 of the second embodiment, the description of similar features to those of the pulse power module 40 of the first embodiment will be omitted.

### 6.1 Configuration

FIG. 4A is a diagram illustrating the magnetic circuit 5 provided in the pulse power module 40 of the second embodiment. FIG. 4B is a sectional view taken along a line B1-B2 shown in FIG. 4A.

The insulation member 60 shown in FIG. 4A and FIG. 4B may include a first insulation member 61, a second insulation member 62, a third insulation member 63 and a fourth insulation member 64.

The first insulation member 61 may cover the first surface 50a of the magnetic core 50 via the fifth insulation member 65.

The first insulation member 61 may be formed to have a substantially circular ring shape extending along the first surface 50a.

The first insulation member 61 may be formed of an insulating material having a high thermal conductivity. The first insulation member 61 may be formed of a ceramic material including at least one of alumina, yttria and aluminum nitride, for example.

The first insulation member 61 may be formed by thermal spraying.

The first insulation member 61 may have a thickness of around 2.5 mm, for example.

The second insulation member 62 may cover the second surface 50b of the magnetic core 50 via the fifth insulation member 65.

The second insulation member 62 may be formed to have a substantially circular ring shape extending along the second surface 50b.

The second insulation member 62 may be formed of an insulating material having a high thermal conductivity. The second insulation member 62 may be formed of a ceramic material including at least one of alumina, yttria and aluminum nitride, for example.

The second insulation member 62 may be formed by thermal spraying.

The second insulation member 62 may have a thickness of around 2.5 mm, for example.

The third insulation member 63 may cover the third surface 50c of the magnetic core 50 via the fifth insulation member 65.

The third insulation member 63 may be formed to have a substantially annular shape extending along the third surface 50c.

The third insulation member 63 may be formed of an insulating material having a high thermal conductivity. The third insulation member 63 may be formed of a ceramic material including at least one of alumina, yttria and aluminum nitride, for example.

The third insulation member 63 may be formed by roller compaction.

The third insulation member 63 may contain a first refrigerant flow path 71 therein.

The third insulation member 63 may have a thickness of around 2.5 mm, for example.

The fourth insulation member 64 may cover the fourth surface 50d of the magnetic core 50 via the fifth insulation member 65.

The fourth insulation member 64 may be formed to have a substantially annular shape extending along the fourth surface 50d.

The fourth insulation member 64 maybe formed of an insulating material having a high thermal conductivity. The fourth insulation member 64 may be formed of a ceramic material including at least one of alumina, yttria and aluminum nitride, for example.

The fourth insulation member 64 may be formed by roller compaction.

The fourth insulation member 64 may contain a second refrigerant flow path 72 therein.

The fourth insulation member 64 may have a thickness of around 2.5 mm, for example.

The fifth insulation member 65 may be disposed between the first to fourth insulation members 61 to 64 and the first to fourth surfaces 50a to 50d of the magnetic core 50, respectively.

The fifth insulation member 65 may be formed of an insulating material having a high thermal conductivity. The fifth insulation member 65 may be formed of a ceramic material including at least one of alumina, yttria and aluminum nitride, for example.

The fifth insulation member 65 may be formed onto the first to fourth surfaces 50a to 50d by thermal spraying.

The fifth insulation member 65 may have a thickness of around 2.5 mm, for example.

The sixth insulation member 66 may cover a winding 80 which is wound around the magnetic core 50 which is covered with the insulation members 61 to 65.

The sixth insulation member 66 may be formed of an insulating material having a high thermal conductivity. The sixth insulation member 66 may be formed of a ceramic material including at least one of alumina, yttria and aluminum nitride, for example.

The sixth insulation member 66 may be formed by thermal spraying onto the magnetic core 50 after having the winding 80 wound thereon. The sixth insulation member 66 may be formed to embed the winding 80 therein.

The sixth insulation member 66 may have a thickness of around 2.5 mm, for example.

Other features of the magnetic circuit 5 involved in the second embodiment may be similar to those of the magnetic circuit 5 involved in the first embodiment.

### 6.2 Manufacturing Process

Processes for manufacturing the magnetic circuit 5 involved in the second embodiment will be described.

FIG. 5 is a flowchart illustrating a process sequence for manufacturing the magnetic circuit 5 shown in FIG. 4A and FIG. 4B.

In step S1, the fifth insulation member 65 may be provided onto the entire surface of the magnetic core 50 by thermal spraying. Specifically, the fifth insulation member 65 may be provided onto each of the first to fourth surfaces 50a to 50d of the magnetic core 50 by thermal spraying.

In step S2, after thermal-spraying the fifth insulation member 65 onto the magnetic core 50, the third and fourth insulation members 63 and 64, which have the first and second refrigerant flow paths 71 and 72 formed therein, may be disposed on the third and fourth surfaces 50c and 50d of the magnetic core 50, respectively.

The first and second refrigerant flow paths 71 and 72 may be previously formed in the third and fourth insulation members 63 and 64, respectively, by roller compaction. Being manufactured by roller compaction, the third and fourth insulation members 63 and 64 can have a high insulating capability.

In step S3, after thermal-spraying the fifth insulation member 65 onto the magnetic core 50, the first and second insulation members 61 and 62 may be provided on the first and second surfaces 50a and 50b of the magnetic core 50, respectively, by thermal spraying.

In step S4, after the magnetic core 50 is covered with the first to fifth insulation members 61 to 65, the winding 80 may be wound around the magnetic core 50.

Instep S5, after the winding 80 is wound around the magnetic core 50, the sixth insulation member 66 may be provided on the magnetic core 50 by thermal spraying. Specifically, the sixth insulation member 66 may be thermal-sprayed on the surfaces of the first to fourth insulation members 61 to 64 as well as on the winding 80 wound on these members, so as to embed the winding 80 in the sixth insulation member 66.

Other features of the pulse power module 40 of the second embodiment may be similar to those of the pulse power module 40 of the first embodiment.

According to the above-described configuration of the magnetic circuit 5 in the second embodiment, the winding 80 is covered with the sixth insulation member 66, making it possible to further improve the insulation capability of the winding 80.

As a result, the magnetic circuit 5 will be hard to break down, and thus the pulse power module 40 of the second embodiment can be improved in durability.

### 7. Magnetic Circuit in Pulse Power Module of Third Embodiment

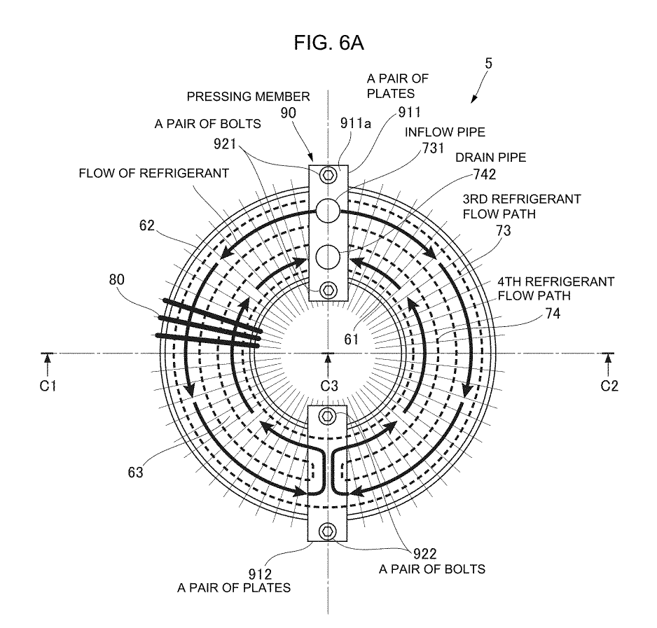

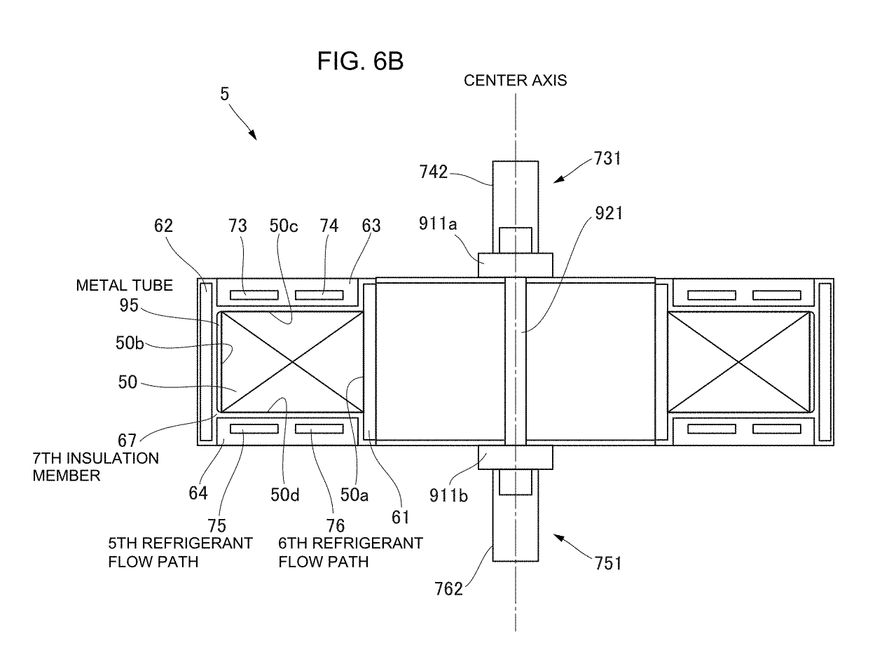

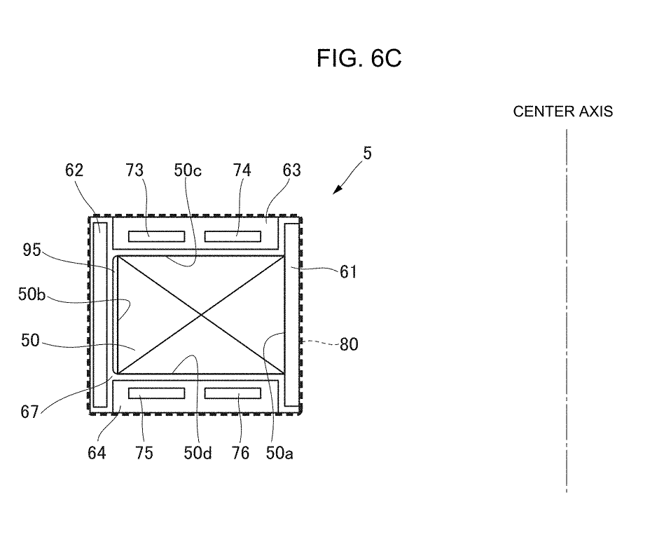

A magnetic circuit 5 provided in a pulse power module of the third embodiment will be described using FIG. 6A to FIG. 6C.

The magnetic circuit 5 involved in the third embodiment may be configured to have a seventh insulation member 67, a pressing member 90 and a metal tube 95 in addition to the features of the magnetic circuit 5 in the second embodiment.

Furthermore, the magnetic circuit 5 involved in the third embodiment may have a different structure from the magnetic circuit 5 in the second embodiment with respect to the refrigerant flow path 70.

In the configuration of the pulse power module 40 of the third embodiment, the description of similar features to those of the pulse power module 40 of the second embodiment will be omitted.

FIG. 6A is a diagram illustrating the magnetic circuit 5 provided in the pulse power module 40 of the third embodiment. FIG. 6B is a sectional view taken along a line C1-C2 shown in FIG. 6A. FIG. 6C is a sectional view taken along a line C1-C3 shown in FIG. 6A.

Note that fine radial lines in FIG. 6A indicate the position for winding the winding 80 thereon, and the winding 80 wound on the position is partly omitted from the drawing. In FIG. 6B, the winding 80 is entirely omitted from the drawing.

The magnetic circuit 5 in FIG. 6A to FIG. 6C may not necessarily include the fifth or the sixth insulation member 65 or 66.

The first to fourth insulation members 61 to 64 in FIG. 6A to FIG. 6C may cover the first to fourth surfaces 50a to 50d of the magnetic core 50, respectively, without interlacing the fifth insulation member 65.

The first insulation member 61 may cover the first surface 50a of the magnetic core 50 directly.

The second to fourth insulation members 62 to 64 may cover the second to fourth surfaces 50b to 50d of the magnetic core 50 while interlacing the seventh insulation member 67.

Otherwise, the first to fourth insulation members 61 to 64 of the third embodiment may have the same features as the first to fourth insulation members 61 to 64 of the second embodiment.

The seventh insulation member 67 in FIG. 6A to FIG. 6C may be formed of an elastic insulating material. For example, the seventh insulation member 67 may be formed of a silicone resin.

The seventh insulation member 67 may be disposed between the second to fourth insulation members 62 to 64 and the second to fourth surfaces 50b to 50d of the magnetic core 50, respectively.

Specifically, the elastic seventh insulation member 67 may be disposed to fill a gap between the metal tube 95 on the second surface 50b of the magnetic core 50 and the second insulation member 62. The elastic seventh insulation member 67 may be disposed to fill a gap between the third surface 50c of the magnetic core 50 and the third insulation member 63. The elastic seventh insulation member 67 may be disposed to fill a gap between the fourth surface 50d of the magnetic core 50 and the fourth insulation member 64.

The seventh insulation member 67 may be disposed to fill gaps between adjacent ones of the first to fourth insulation members 61 to 64.

The metal tube 95 in FIG. 6A to FIG. 6C may be formed to extend in the circumferential direction of the second surface 50b of the magnetic core 50, which has a substantially circular ring shape.

The metal tube 95 may be provided in direct contact with on the second surface 50b of the magnetic core 50.

The metal tube 95 may be disposed between the seventh insulation member 67 and the second surface 50b of the magnetic core 50.

The metal tube 95 has an end face that may be formed to be a curved surface. A radially-outward edge of the end face of the metal tube 95 may be round-chamfered.

The metal tube 95 may be formed of a metal material such as stainless steel, for example.

The pressing member 90 in FIG. 6A may press the third and fourth insulation members 63 and 64 onto the third and fourth surfaces 50c and 50d of the magnetic core 50, respectively.

The pressing member 90 may include a pair of plates 911, another pair of plates 912, a pair of bolts 921 and another pair of bolts 922.

The pair of plates 911 may be placed across the magnetic core 50 in the radial direction thereof from the inside of the first insulation member 61 to the outside of the second insulation member 62.

The pair of plates 911 may hold the magnetic core 50, which is covered with the first to fourth insulation members 61 to 64 and the seventh insulation member 67, by clamping the magnetic core 50 in the direction of the center axis thereof.

The pair of plates 911 may hold the magnetic core 50 in such a manner that the elastic seventh insulation member 67 comes in tight contact with the third and fourth insulation members 63 and 64 and the third and fourth surfaces 50c and 50d of the magnetic core 50, and is deformed to be thinner.

The pair of bolts 921 may secure the pair of plates 911 to hold the magnetic core 50 therebetween.

The pair of plates 912 may be placed in the symmetrical position to the pair of plates 911 about the center axis of the magnetic core 50.

Similarly to the pair of plates 911, the pair of plates 912 may hold the magnetic core 50, which is covered with the first to fourth insulation members 61 to 64 and the seventh insulation member 67, by clamping the magnetic core 50.

The pair of bolts 922 may secure the pair of plates 912 to hold the magnetic core 50 therebetween.

The refrigerant flow path 70 in the embodiment of FIG. 6A to FIG. 6C may include third and fourth refrigerant flow paths 73 and 74 as an alternative to the first refrigerant flow path 71 shown in FIG. 4A and FIG. 4B.

Each of the third and fourth refrigerant flow paths 73 and 74 may be disposed inside the third insulation member 63 in face to the third surface 50c of the magnetic core 50.

The third and fourth refrigerant flow paths 73 and 74 may be connected to each other at least at one point.

The third refrigerant flow path 73 may be arranged outside the fourth refrigerant flow path 74 in the radial direction of the magnetic core 50. The fourth refrigerant flow path 74 maybe arranged inside the third refrigerant flow path 73 in the radial direction of the magnetic core 50.

The third refrigerant flow path 73 may be provided with an inlet port for inletting the refrigerant therein. The inlet port may be connected to an inflow pipe 731 which is connected to an external radiator and the like. The inlet port may be connected to the inflow pipe 731 through one 911a of the pair of plates 911.

The fourth refrigerant flow path 74, which interconnects with the third refrigerant flow path 73, may be provided with an outlet port for letting the refrigerant out therefrom. The outlet port may be connected to a drain pipe 742 which is connected to an external radiator and the like. The outlet port may be connected to the drain pipe 742 through one 911a of the pair of plates 911.

In FIG. 6A to FIG. 6C, the refrigerant flow path 70 may also include fifth and sixth refrigerant flow paths 75 and 76 as an alternative to the second refrigerant flow path 72 shown in FIG. 4A and FIG. 4B.

Each of the fifth and sixth refrigerant flow paths 75 and 76 may be disposed inside the fourth insulation member 64 in face to the fourth surface 50d of the magnetic core 50.

The fifth and sixth refrigerant flow paths 75 and 76 may be connected to each other at least at one point.

The fifth refrigerant flow path 75 may be arranged outside the sixth refrigerant flow path 76 in the radial direction of the magnetic core 50. The sixth refrigerant flow path 76 maybe arranged inside the fifth refrigerant flow path 75 in the radial direction of the magnetic core 50.

The fifth refrigerant flow path 75 may be provided with an inlet port for inletting the refrigerant therein. The inlet port may be connected to an inflow pipe 751 which is connected to an external radiator and the like. The inlet port may be connected to the inflow pipe 751 through the other 911b of the pair of plates 911.

The sixth refrigerant flow path 76, which interconnects with the fifth refrigerant flow path 75, may be provided with an outlet port for letting the refrigerant out therefrom. The outlet port maybe connected to a drainpipe 762 which is connected to an external radiator and the like. The outlet port maybe connected to the drain pipe 762 through the other 911b of the pair of plates 911.

Otherwise, the refrigerant flow path 70 may have the same features as the refrigerant flow path 70 of the second embodiment.

The refrigerant flowing in the inflow pipe 731 may flow from the inlet port of the third refrigerant flow path 73 into the third refrigerant flow path 73 and then flow through the third refrigerant flow path 73.

The refrigerant flowing through the third refrigerant flow path 73 may flow into the fourth refrigerant flow path 74 via the connection point between the third refrigerant flow path 73 and the fourth refrigerant flow path 74 and then flow through the fourth refrigerant flow path 74.

The refrigerant flowing through the fourth refrigerant flow path 74 may flow from the outlet port of the fourth refrigerant flow path 74 to the drain pipe 742 and then flow to the external radiator and the like.

Likewise, the refrigerant flowing in the inflow pipe 751 may flow from the inlet port of the fifth refrigerant flow path 75 into the fifth refrigerant flow path 75 and then flow through the fifth refrigerant flow path 75.

The refrigerant flowing through the fifth refrigerant flow path 75 may flow into the sixth refrigerant flow path 76 via the connection point between the fifth refrigerant flow path 75 and the sixth refrigerant flow path 76 and then flow through the sixth refrigerant flow path 76.

The refrigerant flowing through the sixth refrigerant flow path 76 may flow from the outlet port of the sixth refrigerant flow path 76 to the drain pipe 762 and then flow to the external radiator and the like.

Otherwise, the pulse power module 40 of the third embodiment may have the same features as the pulse power module 40 of the second embodiment.

According to the above-described configuration of the magnetic circuit 5 in the third embodiment, the elastic seventh insulation member 67 may be disposed to fill the gaps between the magnetic core 50 and the metal tube 95, on one hand, and the second to fourth insulation members 62 to 64 which cover the periphery of the magnetic core 50 and the metal tube 95.

Thus, the magnetic circuit 5 in the third embodiment may reduce the thermal contact resistance between the magnetic core 50 and the metal tube 95, on one hand, and the second to fourth insulation members 62 to 64, on the other hand. In addition, even while the magnetic core 50, the metal tube 95 and the second to fourth insulation members 62 to 64 have different coefficients of thermal expansion from each other, the magnetic circuit 5 in the third embodiment can reduce generation of thermal stress because the elastic seventh insulation member 67 severs as a buffer.

Thus, the magnetic circuit 5 in the third embodiment can efficiently transmit the heat generated from the magnetic core 50 to the refrigerant in the refrigerant flow path 70. In addition, the magnetic circuit 5 in the third embodiment can reduce breakage of the second to fourth insulation members 62 to 64, the magnetic core 50 and other components.

Furthermore, in the magnetic circuit 5 involved in the third embodiment, the pressing member 90 can press the third and fourth insulation members 63 and 64, which contain the refrigerant flow paths 70 therein, onto the third and fourth surfaces 50c and 50d of the magnetic core 50, which are more likely to generate heat. Moreover, the magnetic circuit 5 in the third embodiment may press the elastic seventh insulation member 67 onto the third and fourth surfaces 50c and 50d of the magnetic core 50 to such an extent that the seventh insulation member 67 is deformed thinner.

Thus, the magnetic circuit 5 in the third embodiment may further reduce the thermal contact resistance between the magnetic core 50 and the third and fourth insulation members 63 and 64, as well as reduce the heat resistance of the seventh insulation member 67 itself.

Accordingly, the magnetic circuit 5 involved in the third embodiment can more efficiently transmit the heat generated from the magnetic core 50 to the refrigerant in the refrigerant flow path 70.

In the magnetic circuit 5 of the third embodiment, the metal tube 95 is provided on the second surface 50b of the magnetic core 50 and the end face of the metal tube 95 is formed to be a curved surface, making it possible to reduce occurrence of electric field concentration at the outer peripheral rim of the magnetic core 50 having the metal tube 95 provided thereon.

Therefore, the magnetic circuit 5 in the third embodiment can reduce breakage caused by the occurrence of electric field concentration.

Thus, in the pulse power module 40 of the third embodiment, the magnetic circuit 5 can be adequately cooled even while used in air, making the magnetic circuit 5 harder to break down. Thus, the durability is further improved.

### 8. Magnetic Circuit in Pulse Power Module of Fourth Embodiment

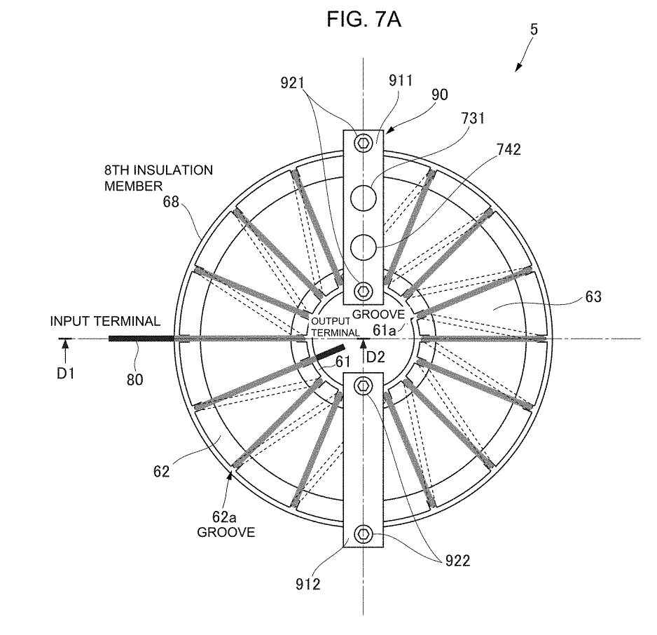

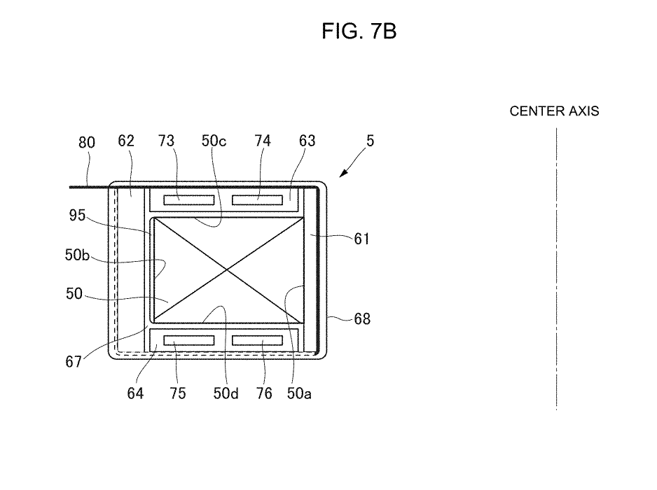

A magnetic circuit 5 provided in a pulse power module of the fourth embodiment will be described using FIG. 7A and FIG. 7B.

The magnetic circuit 5 involved in the fourth embodiment may have a different structure from the magnetic circuit 5 in the third embodiment with respect to the first and second insulation members 61 and 62.

Furthermore, the magnetic circuit 5 involved in the third embodiment may be configured to have an eighth insulation member 68 in addition to the features of the magnetic circuit 5 in the third embodiment.

In the configuration of the pulse power module 40 of the fourth embodiment, the description of similar features to those of the pulse power module 40 of the third embodiment will be omitted.

FIG. 7A is a diagram illustrating the magnetic circuit 5 provided in the pulse power module 40 of the fourth embodiment. FIG. 7B is a sectional view taken along a line D1-D2 shown in FIG. 7A.

The first and second insulation members 61 and 62 may be provided with a plurality of grooves 61a and 62a in the positions for winding the winding 80 thereon.

The grooves 61a and 62a may be formed in such a number that corresponds to the winding number of the winding 80 at intervals corresponding to the winding intervals.

It may also be possible to form a plurality of ridges in place of the grooves 61a and 62a on the first and second insulation members 61 and 62. In that case, a pair of ridges may be formed in place of one groove 61a, for example.

Other features of the first and second insulation members 61 and 62 may be similar to those of the first and second insulation members 61 and 62 involved in the third embodiment.

In the embodiment shown FIG. 7A and FIG. 7B, the eighth insulation member 68 may cover the winding 80 which is wound on the magnetic core 50 which has been covered with the first to fourth and seventh insulation members 61 to 65 and 67. Note that the part of the winding 80 covered with the eighth insulation member 68 is shown by gray bold lines for convenience. In addition, the second and third insulation members 62 and 63, which may be covered with the eighth insulation member 68, are shown by solid lines in FIG. 7A.

The eighth insulation member 68 may be formed of a resin material having a high insulation capability and a high thermal durability. For example, the eighth insulation member 68 may be formed of a resin material including at least one of silicone resin, epoxy resin and polyimide resin.

The eighth insulation member 68 may be formed by molding onto the magnetic core 50 after having the winding 80 wound thereon. The eighth insulation member 68 may be formed in such a manner that the winding 80 is embedded in the eighth insulation member 68.

Otherwise, the pulse power module 40 of the fourth embodiment may have the same features as the pulse power module 40 of the third embodiment.

According to the above-described configuration of the magnetic circuit 5 involved in the fourth embodiment, the intervals between the adjacent lines of the winding 80 can be fixed by the grooves 61a and 62a, and the winding 80 is covered with the eighth insulation member 68. Thus, the insulation capability of the winding 80 can be still more improved.

As a result, the magnetic circuit 5 is made harder to break down, and the durability of the pulse power module 40 of the fourth embodiment can be further improved.

9. Magnetic Circuit in Pulse Power Module of fifth Embodiment

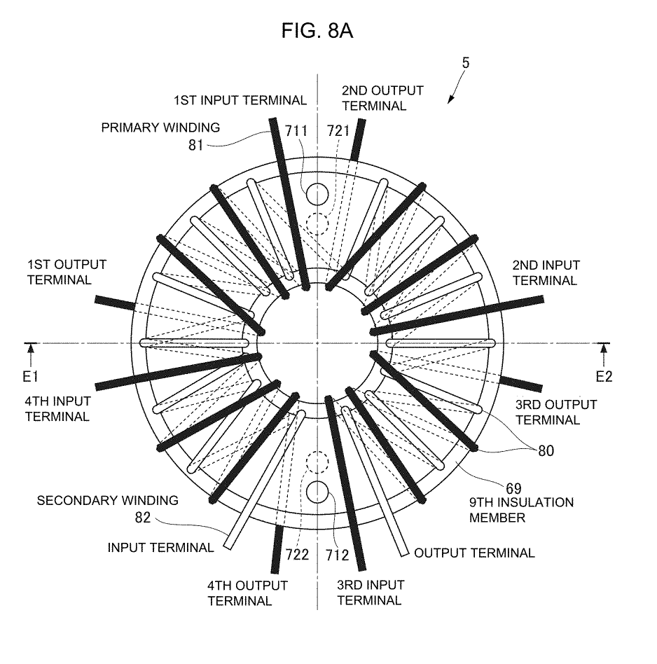

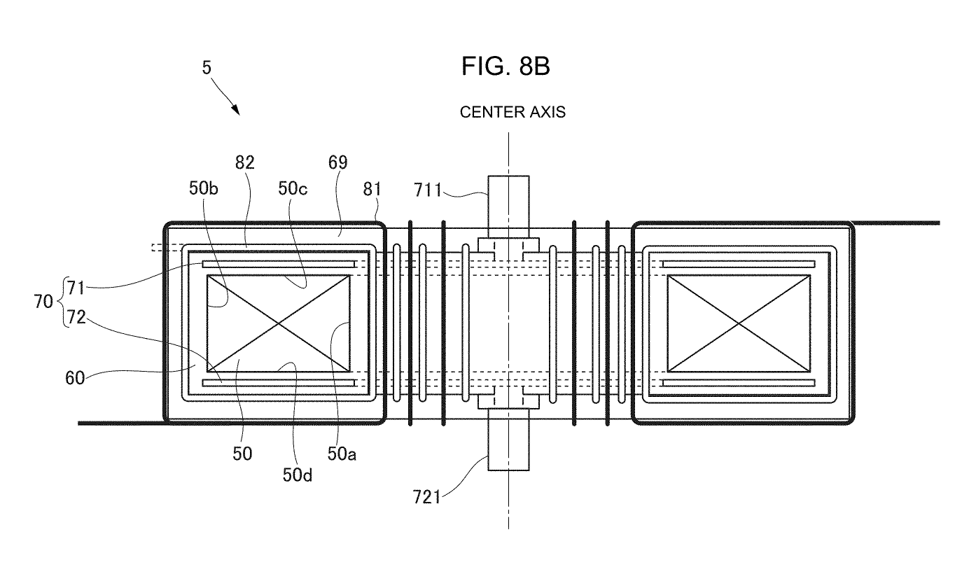

A magnetic circuit 5 in a pulse power module of the fifth embodiment will be described using FIG. 8A and FIG. 8B.

The magnetic circuit 5 in the fifth embodiment may be an example where the magnetic circuit 5 involved in the first embodiment is applied to the transformer TC1 show in FIG. 1.

Specifically, the magnetic circuit 5 in the fifth embodiment may be mainly different from the magnetic circuit 5 in the first embodiment with respect to the configuration of the winding 80.

In the configuration of the pulse power module 40 of the fifth embodiment, the description of similar features to those of the pulse power module 40 of the first embodiment will be omitted.

FIG. 8A is a diagram illustrating the magnetic circuit 5 provided in the pulse power module 40 of the fifth embodiment. FIG. 6B is a sectional view taken along a line E1-E2 shown in FIG. 8A.

The winding 80 in FIG. 8A and FIG. 8B may include a primary winding 81 and a secondary winding 82.

The primary and secondary windings 81 and 82 may be wound around the magnetic core 50 covered with the insulation member 60.

The winding direction of the primary winding 81 may be reverse to the winding direction of the secondary winding 82.

The winding number of the secondary winding 82 may be greater than the winding number of the primary winding 81.

The primary winding 81 may include four pairs of input and output terminals. The secondary winding 82 may include a pair of input and output terminals.

The secondary winding 82 may be wound around the insulation member 60 that covers the magnetic core 50.

The secondary winding 82, which is wound around the insulation member 60 that covers the magnetic core 50, may be covered with a ninth insulation member 69.

The primary winding 81 may be wound around the ninth insulation member 69 that covers the secondary winding 82. In FIG. 8A, the part covered with the ninth insulation member 69, such as the primary winding 81, is partly shown by a solid line, for convenience sake.

In the fifth embodiment, a pulsing current can flow through an input terminal of the primary winding 81 into the magnetic circuit 5.

When the current flows from the input terminal through the primary winding 81, a pulsing current can flow in the reversed direction through the secondary winding 82 due to electromagnetic induction. At that time, the voltage across the secondary winding 82 changes depending on the winding ratio between the primary winding 81 and the secondary winding 82, and the current corresponding to the voltage can flow through the secondary winding 82.

Otherwise, the magnetic circuit 5 in the fifth embodiment may have the same configuration as the magnetic circuit 5 in the first embodiment.

According to the above-described features, the magnetic circuit 5 in the fifth embodiment is applicable to the transformer TC1. Like the magnetic circuit 5 in the first embodiment, the magnetic circuit 5 in the fifth embodiment can be adequately cooled even when used in air, and can be reduced in size and weight.

As a result, the pulse power module 40 of the fifth embodiment can be made smaller and lighter, like the pulse power module 40 in the first embodiment.

### 10. Others

### 10.1 Modification of Magnetic Core

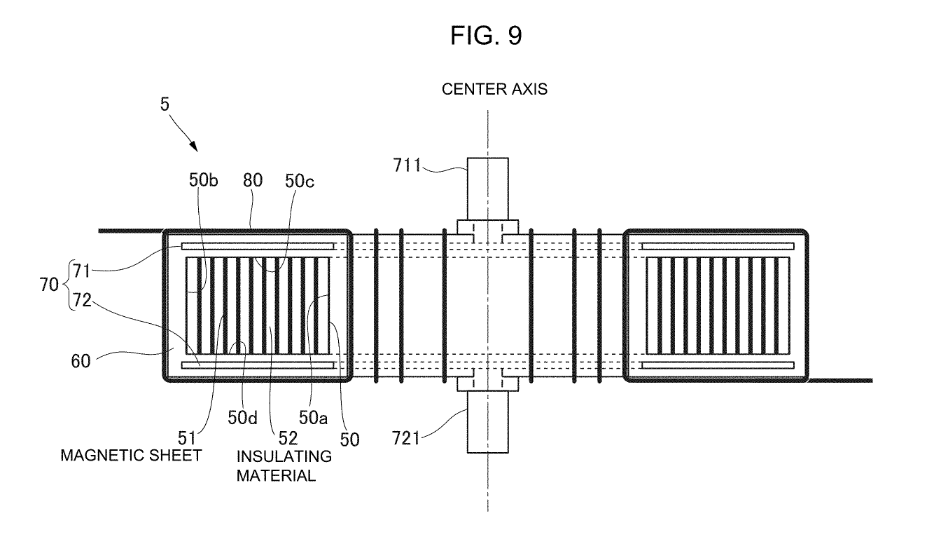

A modification of the magnetic core 50 will be described using FIG. 9.

FIG. 9 is a diagram illustrating the modification of the magnetic core 50.

The above-described magnetic cores 50 involved in the first to fifth embodiments may have a structure constituted of a single bulk of magnetic body.

The magnetic core 50 in the modification may have a structure in which multiple magnetic bodies are laminated.

However, the structure of the magnetic core 50 in the modification can definitely differ from the structure of the magnetic core shown in FIG. 2.

Specifically, the laminated structure of multiple magnetic bodies in the magnetic core 50 of the modification is the structure of a single magnetic core 50 itself. On the contrary, the structure of the magnetic core shown in FIG. 2 can be a structure wherein a plurality of magnetic cores 42 are stacked in a multistage unit.

The magnetic core 50 in the modification may have the same structure as a magnetic core described in a prior art document “Japanese Patent Application Publication No. 1993-55057”.

Namely, the magnetic core 50 in the modification may be formed by superposing insulating material 52 of a thin belt shape on a magnetic sheet 51 and winding them into a substantially annular convolution. Alternatively, the magnetic core 50 in the modification may be formed by winding a magnetic sheet 51 of a thin belt shape, coated with insulating material 52, into a substantially annular convolution. The magnetic core 50 in the modification may have magnetic sheets 51 laminated in the radial direction to form a multilayered structure.

The insulating material 52 may be formed of an insulating material including at least one of alumina and silica.

The magnetic sheet 51 may be formed of a ferromagnetic material having a higher thermal conductivity than the insulating material 52.

According to this configuration, the heat generated from the magnetic core 50 involved in the modification can be easily transmitted in the direction toward the center axis of the magnetic core 50 through the magnetic sheet 51 that has a higher thermal conductivity than the insulating material 52. Then, the heat generated from the magnetic core 50 in the modification can be easily transmitted through the first and fourth surfaces 50c and 50d of the magnetic core 50 to the refrigerant flow path 70.

Thus, the magnetic core 50 in the modification can be more efficiently cooled.

### 10.2 Other Modifications

The gas laser apparatus 1 is not limited to an excimer laser apparatus, but may be a fluorine molecular laser apparatus that uses a fluorine gas and a buffer gas as the laser gas.

The first discharge electrode 11a may be an anode electrode, not a cathode electrode, and the second discharge electrode 11b may be a cathode electrode, not an anode electrode. In that case, for example, the winding directions of the primary and secondary sides of the transformer TC1 of the pulse power module 40 may be set equal to each other to cause the first and second discharge electrodes 11a and 11b to serve as anode and cathode electrodes, respectively.

It should be appreciated for a person skilled in the art that the respective features of the above-described embodiments, including the modifications, can be applied to one another.

For example, the modification of the magnetic core 50 shown in FIG. 9 may be applied to the magnetic core 50 of the magnetic circuit 5 involved in any of the first to fifth embodiments.

The foregoing description is intended to be merely illustrative rather than limiting. It should therefore be appreciated for a person skilled in the art that variations may be made in the embodiments of the present disclosure without departing from the scope as defined by the appended claims.

The terms used throughout the specification and the appended claims are to be construed as “open-ended” terms. For example, the term “include” or “included” is to be construed as “including but not limited to”. The term “have” is to be construed as “having but not limited to”. Also, the modifier “one (a/an)” described in the specification and recited in the appended claims is to be construed to mean “at least one” or “one or more”.

What is claimed is:

1. A pulse power module applying a high voltage in the form of a pulse across a pair of discharge electrodes disposed in a laser chamber located within a gas laser apparatus, comprising a magnetic circuit comprising:
a magnetic core;
an insulation member configured to contain a refrigerant flow path therein and cover the periphery of the magnetic core; and
a winding wound around the insulation member.

2. The pulse power module as set forth in claim 1, wherein the magnetic core is formed to have a substantially annular shape, and
the refrigerant flow path in the insulation member is disposed in face to a surface substantially perpendicular to a center axis of the magnetic core.

3. The pulse power module as set forth in claim 2, wherein the insulation member comprises:
a first insulation member covering a first surface configured to be an inner circumferential surface of the magnetic core;
a second insulation member covering a second surface configured to be an outer circumferential surface of the magnetic core;
a third insulation member covering a third surface substantially perpendicular to the center axis of the magnetic core; and
a fourth insulation member covering a fourth surface substantially perpendicular to the center axis of the magnetic core and on opposite side to the third surface, wherein
the refrigerant flow path is disposed in face to the third surface inside the third insulation member, and is disposed in face to the fourth surface inside the fourth insulation member.

4. The pulse power module as set forth in claim 3, wherein the magnetic circuit further comprises a fifth insulation member disposed between the first to fourth insulation members and the magnetic core.

5. The pulse power module as set forth in claim 4, wherein the magnetic circuit further comprises a sixth insulation member configured to cover the winding.

6. The pulse power module as set forth in claim 3, wherein the magnetic circuit further comprises a seventh insulation member disposed between the second to fourth insulation members and the magnetic core.

7. The pulse power module as set forth in claim 6, wherein the magnetic circuit further comprises a metal tube disposed between the seventh insulation member and the second surface, the metal tube having an end face formed to be a curved surface.

8. The pulse power module as set forth in claim 7, wherein the magnetic circuit further comprises a pressing member configured to press the third insulation member and the fourth insulation member onto the third surface and the fourth surface, respectively.

9. The pulse power module as set forth in claim 8, wherein the magnetic circuit further comprises an eighth insulation member configured to cover the periphery of the winding.

10. The pulse power module as set forth in claim 5, wherein each of the first to sixth insulation members is formed of at least one of alumina, yttria and aluminum nitride.

11. The pulse power module as set forth in claim 6, wherein the seventh insulation member is formed of a silicone resin.

12. The pulse power module as set forth in claim 9, wherein the eighth insulation member is formed of at least one of a silicone resin, an epoxy resin and a polyimide resin.

13. The pulse power module as set forth in claim 1, wherein the magnetic circuit is at least one of a magnetic switch and a transformer.
